(19) United States
(12) Patent Application Publication
(10) Pub. No.: US 2017/0142276 A1
(43) Pub. Date: May 18, 2017

(54) MOBILE NETWORKED SYSTEM FOR CAPTURING AND PRINTING THREE DIMENSIONAL IMAGES

(71) Applicants: John Lacagnina, Rochester, NY (US); Gustavo R. Paz-Pujalt, Rochester, NY (US); Roy Y. Taylor, Scottsville, NY (US)

(72) Inventors: John Lacagnina, Rochester, NY (US); Gustavo R. Paz-Pujalt, Rochester, NY (US); Roy Y. Taylor, Scottsville, NY (US)

(21) Appl. No.: 15/274,911

(22) Filed: Sep. 23, 2016

Related U.S. Application Data
(60) Provisional application No. 62/257,112, filed on Nov. 18, 2015.

(51) Int. Cl. H04N 1/00; H04N 5/225; B33Y 50/02; B33Y 30/00; B29C 67/00; H04N 13/02; B33Y 10/00

(52) U.S. Cl. CPC H04N 1/00827; H04N 13/0221; H04N 13/0275; H04N 1/00278; H04N 5/2251; H04N 13/0246; B33Y 10/00; B33Y 30/00; B29C 67/0088; B33Y 50/02

(57) ABSTRACT

A system for and method of remotely capturing 3 dimensional information optimized for 3 dimensional printing and printing a replica or avatar to be delivered to a customer, the method comprising a 3D image capture step consisting of capturing an image of a static object from a minimally sufficient rotationally displaced set of perspectives around the object, using the cloud to create, process, and print a replica or avatar of the object and delivering the rendered replica or avatar to a customer.

### CROSS-REFERENCE TO RELATED PATENT APPLICATIONS

Priority for this patent application is based upon provisional patent application 62/257,112 (filed on Nov. 18, 2015). The disclosure of this United States patent application is hereby incorporated by reference into this specification.

### FIELD OF THE INVENTION

The present invention relates to a mobile and portable networked system to automate and optimize the capture of images in three dimensions for three-dimensional (3D) printing of articles on site or on a distributed printer network.

### BACKGROUND OF THE INVENTION

Inkjet printers have revolutionized the printing industry with the introduction of new substrates, colors, finishes and special textures. The introduction of 3D inkjet printers has added to this transformation the ability to print solid parts based on input received from computer-aided design (CAD) and other forms of computer graphics engineered for creating digital files with information suitable for 3D printing.

3D inkjet printers work by directing jets of discrete ink droplets to a substrate which maintains an image-wise relationship with the printing head. In the particular case of 3D printing the image-wise relationship is maintained in the X-Y planes of the substrate material as well as building up the Z-direction in a sort of topographic map manner. This permits the creation of three-dimensional objects containing shape, form, texture and color information transmitted from an electronic file. These files must be created or they must be somehow recorded from real 3D objects.

The present invention relates to a method and apparatus for capturing image data from real objects, processing the data and rendering 3D replicas via 3D printing in particular. It will be understood to anyone skilled in the art that there are numerous forms of creating 3D or solid objects including, but not limited to the process of creating a mold based on the digital data followed by numerous forms of casting.

Although 3D printing has been taken to unprecedented levels of sophistication, and the ability to print technically complex objects continues to be improved there remain several problems. One particular problem is the capture of images of 3D objects or forms. That is images of real objects that are not computer generated. Various methods are available comprising the use of a multiplicity of cameras and specialized image stitching software. These methods are expensive due in part to the large number of cameras (henceforth referred to as image capture devices) required and the difficulty of accurate image stitching as the perspectives change. They are impractical for mobile or portable applications due to the mechanical and physical complexity of the systems. They are also extremely delicate in terms of the calibration of the multiple cameras and the large amounts of data that must be handled. Another complication of these methods is that data reduction, including compression, stitching, smoothing and other must be done on the capture site prior to any attempts to transmit the data wirelessly via WIFI or via the cellular telephone network to a central 3D printing and finishing location.

One particular method exists, fractal interpolation of images and volumes, of taking a reduced number of images of known subjects and interpolating the image data to create a synthetic volumetric data file for printing. In one specific case this can be done with human faces to create computer-generated files of the corresponding head. This method takes advantage of known symmetries and expected constituents of the human head to make the interpolation and the corresponding data manipulation somewhat more abbreviated. The results suffer of inaccuracies, visible artifacts, the result of short cuts, and may not be appropriate for certain applications. In addition complex algorithms and sophisticated data manipulating software and apparatus are required.

One caveat to consider is that although 3D image files may be computer generated, or partially computer generated combining image capture and interpolation, their intended use may be more appropriate and practical for 2D display from one side of the object rather than for 3D printing from all sides of the object. One major issue is then how to optimize a combination of optical or real image capture in conjunction with synthetic or computed images to create electronic files acceptable for 3D printing within constraints of cost, portability, image quality and overall convenience.

One particular problem is the need of portable and mobile systems to serve the image capture needs of places, objects and events that by their very nature cannot be moved to a central image capture location. In one particular example museum pieces may not be transportable on account of security and insurance issues, fragility, and due to size and mobility limitations. It is desired to capture 3 dimensional images on site so that they may be archived for study, online viewing, 3D replicas or 3D molds to be casted for sale or distribution. In another example images at events like weddings, sports events, concerts, amusement parks, movie theaters (including 3D showings) cannot be transported to central capture locations, making an irrevocable need for a portable and mobile capture system.

Let it be understood that the term mobile used in the context of 3D image capture is a subset of mobile computing as defined according to accepted terminology in the art as: “taking a computer and all necessary files and software out into the field”. In this particular case it comprises all capture equipment, its corresponding optics, image data managing computing devices, memory, electronic business engines, and multi-channel communication capabilities.

### SUMMARY OF THE INVENTION

Various embodiments of the present invention provide for a mobile and portable networked system to automate and optimize the capture of images in three dimensions for three-dimensional printing of articles on site or on a distributed printer network said system comprising an image capture platform, at least one mirror, at least one image capture device, a processing apparatus, and at least one communications module. The system creates a three dimensional (3D) model to allow for the 3D printing of articles and also two dimensional and three dimensional avatar generation.

In one embodiment of the present invention a set of image capture devices arranged so that they capture a perspective are aligned on an image-wise relationship with a subject wherein each image capture device sensor views and captures two perspectives of the subject from different angles simultaneously by an optical arrangement of mirrors aligned to reflect at least two views of the subject from different views. As those knowledgeable in the field are aware, only features visible in each perspective can discretely become rectified points in the captured image. Therefore, the accuracy of the 3D model improves with the number of perspectives captured.

Another embodiment of the present invention accomplishes the task of capturing the image by at least one linear image sensor, alternatively two parallel linear sensors, or a combination of such, selected to have a frame capture rate optimized to achieve the correct density of pixel information in accordance to the requirements of the 3D printer. Said linear image sensor or sensors is/are coupled in an image-wise relationship with at least one mirror in an optical relationship such that when the camera is rotated about an axis an area scan of the subject is produced from which the image data may be manipulated.

Another embodiment of the present invention accomplishes the capture of simultaneous perspectives using a variety of applications available on smartphones, tablet computers, and the like whence the processing is done in part or in totality within the processing capabilities of the smartphone or tablet computer. Conversely the processing may be done in the cloud or via a web-based application and then submitted for 3D printing. Typically a smartphone equipped with 3D technology will have a parallax barrier display or variation thereof. One particular example comprises four front-facing cameras to create a 3D perspective. In one particular use a person may capture a so-called “selfie” to be used as a source for 3D printing.

The system of the present invention may use any readily available image capture arrangement for capturing image data from real objects to create the 3D image data. Some specific optical arrangements for capturing image data from real objects are abstracted below:
A. area sensor cameras with split field optics to look at different perspectives simultaneously from multiple rotational positions;
B. one single area sensor camera with a high frame rate oriented above the object space aimed radially outward, or with a single 45 degree mirror aimed to fixed pairs of mirrors redirecting perspective view axis inward toward object space; mirror and camera may rotate as a unit, or mirror rotation only is recognized;
C. a single line sensor camera with high frame rate is used as in case B; and
D. a dual single line sensor camera with high frame rate is used as in case C, and with split field optics to record image information simultaneously from opposing 180-degree perspective orientations so that complete 360 degree camera rotation is not needed.

The invention further relates to a method of reducing electronic file sizes by reducing the number of image capture devices involved in the process. This is accomplished in part by the optimal positioning of, and the minimization of, the number of image capture devices used to capture perspective information. One particular preferred embodiment makes use of a telecentric lens in optical relationship with an image capture device.

The invention further provides for retouching or otherwise enhancing images via algorithms like Photoshop™ (manufactured by Adobe Inc.) or a multiplicity of image enhancing software prior to reviewing and or prior to 3D printing.

In yet another embodiment of the present invention, a specialized type of 3D printer would ideally be utilized using a (r, theta, h) cylindrical coordinate system and adding material similar to cutting a part on a lathe, but adding material around a core with variations of radius occurring at different angles around the part and different locations along the lathe bed. In the context of this invention, a cylindrical coordinate system is utilized with the vertical axis through the center of the object space is called r, or the radius to object features from the vertical axis; theta, or the angle from a starting zero angle to 360 degrees, a full revolution about the vertical axis; and h or the height above a platform upon which the object may be placed. When producing replicas of the object, a 3D printer capable of rendering features in the same type of cylindrical coordinate system is therefore optimal, because while conversion from the cylindrical coordinate system (r, theta, h) to a three axis coordinate system (x, y, z) is easy from a mathematical point of view, that adds complication to the programming of the 3D Printer.

In yet another aspect of the present invention a cylinder marked with registration marks serves as the standard for calibrating the capture system against the various image perspectives taken.

Another embodiment of the present invention relates to the optimization of image capture for the purpose of 3D printing comprising the steps of maximizing the capture of areas that are more relevant to the resulting end product. In particular when capturing the image of a human head, more emphasis would be put on capturing data, even if redundant, of the face. This may be achieved by any of several methods including:
use of “smart cameras” optimized to capture higher pixel density in areas of higher interest or need;
data reduction by use of field programmable gated arrays on-board camera;
use of capture mechanism to detect volumetric data of subject including height;
adjusting capture conditions to optimize imaging in connection with subject's height-volume;
preview of image prior to capture via camera and on-site monitor; and
use of attention drawing artifacts (e.g., emoticons) in a live monitor to maintain stillness of subjects while capturing images.

Another embodiment of the present invention comprises the use of smart phone cameras selected to capture a multiplicity of images of the subject's periphery. This is accomplished by one of various means.

In one particular embodiment the subject is stationary while the smartphone camera is rotated about the subject by a motorized system moving the camera about an axis where the subject is at the center.

In another embodiment the smartphone camera may be rotated about the subject by an operator while maintaining the height of the camera at a relative constant level. In another embodiment of the present invention the orbit of the image capture device may be other than circular to obtain the optimal set of capture points for 3D printing. In one particular embodiment the image capture device moves in a hyperbolic orbit or trajectory about the subject(s). In another particular embodiment the image capture device moves in an elliptical orbit or trajectory about the subject(s).

In one particular example a Raspberry Pi™ single board computer drives a digital camera facilitating portability and mobility and on-site data manipulation.

In yet another embodiment of the present invention the subject is placed on a platform that rotates at a certain number of revolutions per minute (RPM) whereas the camera remains stationary.

In yet another embodiment the rotating platform contains concentric markers so that more that one subject may be placed on the markers for optimal image capture.

Another embodiment of the present invention comprises batch processing the images so that histograms are adjusted as to eliminate over and underexposure at least in some frames. This step helps create “structure” in the image in parts that may be over or underexposed thus helping ensure that the 3D printer interprets correctly the image data and does not print swatches where there is 3D over or underexposure.

Another embodiment of the present invention comprises using structured lighting to help ensure that the 3D printer properly interprets the image data. As those skilled in the art are aware, structured lighting is a process of projecting a known pattern (often grids or horizontal bars) onto an object or objects located in a scene. The way that the grid lines deform when striking surfaces allows vision systems to calculate the depth and surface information of the objects in the scene, as is commonly used in structured lighting 3D scanners. The grid lines of the structured lighting may be visible or invisible. Invisible grid lines may either use lines which are outside the normal range of visible light (such as infrared or ultraviolet light) or project patterns of light at extremely high frame rates. In one particular example “structured lighting” may be applied as a means to reduce the number of capture devices and reduce cost and improve 3D capture information.

Another embodiment of the present invention covers the setting of the mechanisms of image capture to produce what is called in the photographic art “bracketing”. Bracketing may be conducted by an individual capture device or camera or by a multiplicity or array of cameras selected to accomplish the best set of bracketing settings to produce a set of images of superior quality for 3D printing. As those skilled in the art are aware, examples of how this bracketing may be achieved include:
Exposure bracketing;
Illumination or flash bracketing;
Depth of field bracketing;
Focus bracketing;
White balance bracketing; and
ISO bracketing.

### BRIEF DESCRIPTION OF FIGURES

Embodiments of the present invention will be described by reference to the following drawings, in which like numerals refer to like elements, and in which:

FIG. 1A is a diagram of an exemplary system for capturing, processing, and printing 3D objects;

FIG. 1B is a block diagram of a method for capturing, processing, and printing 3D objects;

FIG. 1C is a block diagram of an exemplary embodiment of a system for capturing, processing and 3D printing objects;

FIG. 2 is a block diagram of a system for capturing, previewing, order creation, processing and printing 3D objects;

FIG. 3 is a block diagram of a mobile 3D image capture apparatus;

FIGS. 4A and 4B are side views of an image capture device with opposite oblique perspectives;

FIG. 5 is an overhead view of a multiplicity of oblique image capture devices;

FIG. 6 is an overhead view of an area sensor with image splitting optics;

FIG. 7 is an overhead view of area sensor with image splitting optics from a different perspective;

FIG. 8 is a lateral view of a single high rate camera rotating within fixed mirrors;

FIG. 9 is an overhead view of the same rotating high rate camera as is depicted in FIG. 8;

FIG. 10 is a lateral view of an oscillating dual single line sensor camera;

FIG. 11 is a schematic of a single line sensor image capture device;

FIG. 12 is a detailed view of a dual single line sensor image capture device;

FIG. 13 is a view of rotating image formats on an area sensor;

FIG. 14 is a schematic view of a telecentric lens in optical arrangement with an image capture device;

FIG. 15A is a view of a stationary image capture platform with adjustable capture device height and tilt and a rotating subject platform;

FIG. 15B is a view of a stationary image capture platform with adjustable capture device height and rotating subject platform at discreet angle steps adding to 360°;

FIG. 16 is a view of an image capture platform rotating about an stationary subject positioned along a radially graded axis;

FIG. 17 is a view of an image capture platform rotating about an stationary subject positioned along a radially graded axis where the rotation about the subject may follow a circular or an elliptical orbit;

FIGS. 18A and 18B are views of a demountable portable kiosk equipped with a multiplicity of Raspberry Pi™-driven cameras;

FIGS. 19A and 19B are views of a portable kiosk equipped for use with a smartphone; and

FIG. 20 is a block diagram of a method for using the portable kiosk depicted in FIGS. 19A and 19B.

### LIST OF PARTS

The following is a listing of parts presented in the drawings:

The following is a listing of parts presented in the drawings:
5 3D Image Capture and Processing System
10 Portable Kiosk
12 Portable Kiosk
15 Subject
18 Subject
20 3D Image Capture Device
25 Wireless Data Transfer
30 Image Capture Data Store
35 Internet Connection
40 Cloud
45 3D Printer
50 Delivery Location
65 Kiosk Operator
70 Image Capture Template Mat
90 3D Image Capture and Processing Method
95 Method for Capturing 3D Image Data and Creation of 3D Replicas
97 Method for Capturing Previewing, Processing and Printing 3D Objects
98 Representative Apparatus
100 Image Processing Step
101 Processing Apparatus
102 Image Data Demographic Address Association
104 Image and Product Image Review
106 Product Order
108 Yes, Order
109 No, Don't Order
110 Image File ID
112 Calibration Process
120 Storage
121 Storage Step
130 Print Job File Creation
131 Cloud or Network Print Job File Creation
140 3D Print Operations
141 3D Print Operations
150 Finishing Steps
160 Remote Delivery
220 Communications Module
230 3D Subject
240 Work Station (Work Stations)
300 3D Image Capture Step
301 Image Capture Platform (Image Capture Device)
302 Area Sensor Image Capture Device
303 Linear Array Sensors
305 Raspberry Pi™ Controller
310 Split Field Optics (Sensor)
350 Sensor Face (Sensor, Sensor Field)
351 3D Image Capture
400 Object (Object Field, Object Space)
401 Object
410 Mirror Set
411 Reflective Mirror
412 Reflective Mirror
413 Reflective Mirror
418 Mirror
419 Mirror
420 45 Degree Mirror
421 Mirror
422 Mirror
430 45 Degree Mirror
431 Mirror
432 Mirror
500 Center of Object (Field)
550 Area Split
551 Area Split
600 Image Capturing System
700 Fixed Mirror
710 Fixed Mirror
720 Fixed Mirror
730 Fixed Mirror
740 Fixed Mirror
750 Fixed Mirror
760 Fixed Mirror
770 Fixed Mirror
780 Fixed Mirror
800 Processing Unit
900 (Wireless) Data Bus
1000 Cloud Computing and Printing
1010 Camera Lens
1020 45 Degree Mirror
1110 Camera Lens
1120 45 Degree Mirror
1121 45 Degree Mirror
1130 Sensor
1140 Sensor
1300 High Frame Rate Image Capture Device (Split Field Image Capture Device)
1350 Split Field Image Capture Rotating Apparatus
1400 Object Space
1600 Rotating Subject Platform
1700 Adjustable Capture Device Support
1710 Adjustable Capture Device Support Adjustment
1730 Image Capture Device Support
1750 Portable Kiosk
1800 Radially Graded Subject Placement Axis
1900 Rotating Image Capture Device Platform
1920 Circular Orbit
1940 Elliptical Orbit
3000 Telecentric Lens
3001 Image Capture Device
3002 Image Capture Device
3003 Image Capture Device
3004 Image Capture Device

### DETAILED DESCRIPTION

The present invention relates to a mobile and portable networked system to automate and optimize the capture of images in three dimensions for three-dimensional printing of articles on site or on a distributed or cloud printer network.

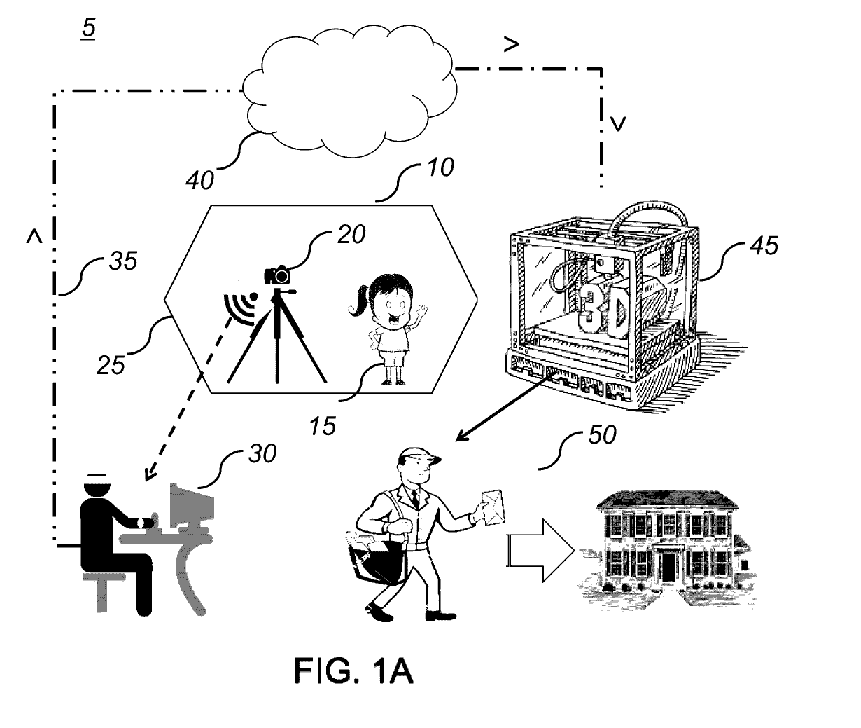

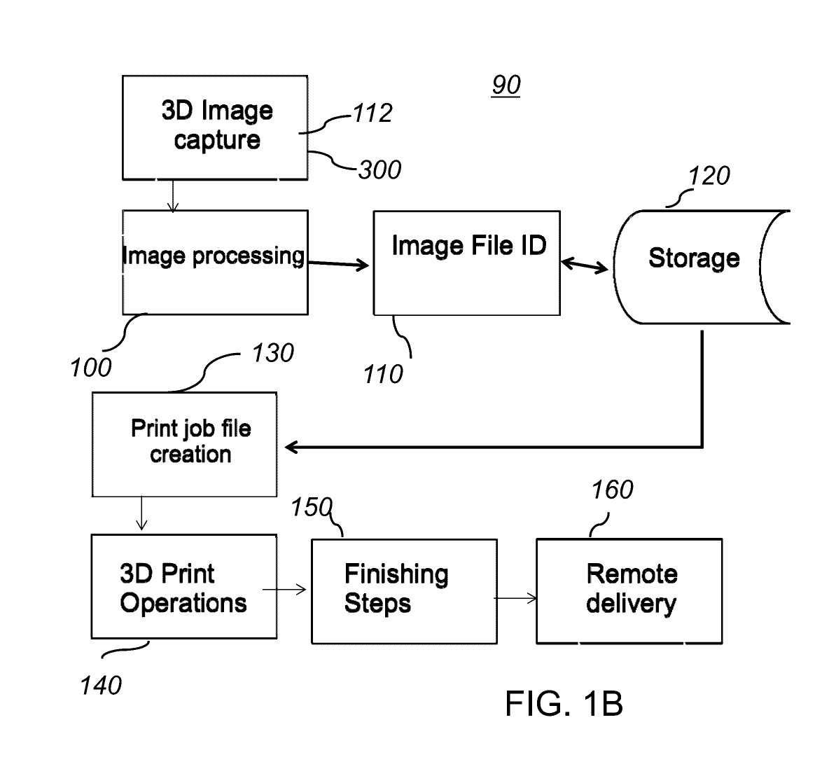

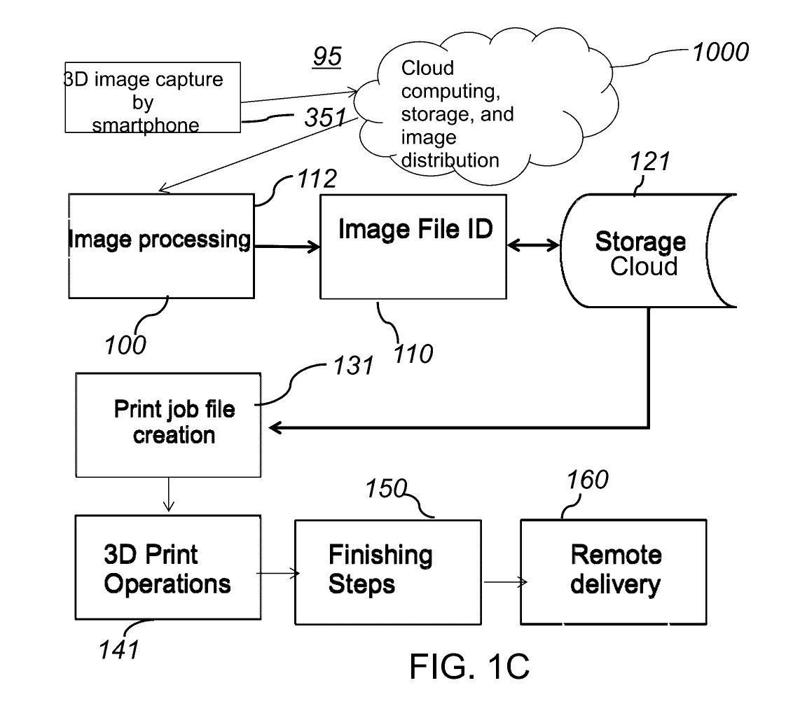

In FIG. 1A a preferred embodiment of an exemplary 3D image capture and processing system 5 is depicted. A subject 15 enters a portable kiosk 10 which is equipped with a 3D image capture device 20. The kiosk structure may be comprised of any material that is used to construct photobooths as are well known in the art. The kiosk structure will be sized to allow for proper focal length for the 3D image capture device 20 appropriate for the given subject 15. A kiosk just large enough to capture images of a single person would not be large enough to capture images of an automobile. In one preferred embodiment of the present invention the kiosk 10 is cylindrical with a diameter of 15 feet and a height of 10 feet. The 3D image capture device 20 could be a 3D digital camera, a cellphone, an I-Phone™ (manufactured by Apple, Inc. of Cupertino, Calif.), a virtual 3D camera, or the like. The 3D image capture device transfers the captured image to an image capture data store 30 through any of a variety of available means such as a blue tooth connection, a wireless local area network (Wifi) connection, a cabled network connection, a wireless mobile phone data network, or the like. The image capture local data store may be a database, a spreadsheet, or the like and may be stored on a universal serial bus (USB) device or the like and connected to an processing algorithm or algorithms via an internet connection and the processing algorithm along with data metrics are located in the cloud 40. As those skilled in the art are aware, the cloud refers to an internet based method of providing shared computer processing resources and data to computers and other devices on-demand. The processing algorithm converts the image data into a desired printable work file which can be transferred to a 3D printer 45 for creation of a 3D replica or avatar of the subject (or their representative's) choosing. The printed replica or avatar is then delivered 50 to a location of the subject's choosing. In FIG. 1B a preferred embodiment 90 of a method for capture and processing is depicted. The image is captured in a 3D image capture step 300 consisting of capturing an image of a static object from a minimally sufficient rotationally displaced set of perspectives around the object.

After the image is captured, an image processing step 100 consists of determining from zones of overlapping features, the variations in a radial direction about a central reference axis (of the object) of the height of features on the object. Points that are identified from different perspectives are called rectified points and locations in space established because the geometry of the capture devices relative to the object space is known and static. Only points visible in two different views can become rectified, (so at least two perspectives of the object will be captured) but prior knowledge of the object features will ease the process. To establish this geometry, the physical location of the capture devices relative to the central reference axis can either be measured or fixed, or alternately determined by a calibration process 112 of capturing images from a known object or objects that have overlaid grid patterns for easy rectification of grid points. An image file is created which contains all the appropriate features of the captured 3D image. This image file includes a 3 dimensional printing model generated by using the depth information obtained from the rectified points.

After image processing 100, the image file ID 110 comprises a database of identified rectified points from at least two different perspectives and their locations relative to the reference grid images taken during the calibration process 112. The data would preferably be in the form of (r, theta, h) where r is the radius from the reference axis to the rectified point, theta is the rotational position of the rectified point, and h is the height of the rectified point to a base plane perpendicular to the object space reference axis as those skilled in the art are aware. Referring again to FIG. 1B, the database may include multiple entries for each rectified point as seen from different pairs of perspectives. A subsequent process will statistically determine the best fit values for those points prioritized to generate a suitable replica of the object using the depth data determined in the image processing step 100.

The database created in the image file ID 110 is stored in a storage 120 which comprises saving the database in a computer file by any number of ways to correlate the database with object identification so that a replica can eventually made from the data and can be correctly identified with the original object and circumstances of the image capture, such as illumination, time of exposure, retakes. Data stored in storage 120 may have additional data added to the image file data and this data may be processed further in the Image File ID step 110 as and if additional data is collected or created in the image processing step 100.

After the image file data has been stored, a print job file is created. Print job file creation 130 consists of the process of setting up a replica making machine with access to the database and recording the object name and other capture variables along with at least one serial number or icon that may be printed directly on a replica for later correlation to the order that promulgated the 3D image capture process 300 to begin with.

After the 3D replica print job file has been created, a 3D replica or avatar is printed via a 3D printing device. 3D Print Operations 140 consist of laying down materials onto a suitable substrate to recreate the (radius, theta, height) variations recorded in the database computer file in a proportional manner on the substrate. The proportional manner refers to the volumetric scale of the replica relative to the original object. The suitable substrate may be a form roughly equivalent to the form of the object, so that amount of materials needed for 3D printing and the time to complete the 3D printing is reduced. It is anticipated that under certain circumstances a complete 360-degree replica is not intended or made, but that a rotational angle of less than 360 degrees is 3D printed even though full 360 degrees data is potentially available in database file. This provides the advantage of allowing the image capture device to be hardwired to the processing unit.

The 3D printing may produce either a replica of the object or a mold of the object from the rectified points.

Upon printing a replica, the replica is finalized. Finishing steps 150 consist of polishing the raw printed object prior to printing a final layer on the 3D replica to impart color and density information and a potential protective layer, for example to fix the color, density layer or encapsulate it with waterproofing or ultraviolet protection to prevent the replica from becoming brittle. This may be determined from a fewer number of perspectives than used to determine the rectified points or from different image capture devices. The polishing process may consist of readily known processes such as ablation via compressed fluid be it air, water, sand or any other suitable fluid. In addition the polishing may be done by laser finishing process such as ablation. The post printing processing may include the steps of laser ablation to smooth the printed object. In one particular example the laser ablation apparatus is computer driven using data received from the image capture step as input. As those skilled in the art are aware, laser ablation is the process of removing material from a solid (or occasionally liquid) surface by irradiating it with a laser beam. At low laser flux, the material is heated by the absorbed laser energy and evaporates or sublimates. The laser ablation may be performed on either an avatar to be created or a mold to be used to create the avatar.

After the replica or avatar is finished it gets delivered to the end user. Remote delivery 160 refers to the potential that the image capture device and the 3D printing device may be in entirely separate physical locations. For example, the image capture device may be designed to be portable and taken to a remote location, while the 3D printing device is centrally located serving more than one capture device. Therefore, the delivery of the replica from the 3D printing device may be achieved with services of physical mail or package delivery, while conversely the image capture information from Step 300 is digitally transmitted to a central computer database processor by any number of means including telephone, the internet web, or satellite transmission, or combinations thereof as examples.

Referring to FIG. 1C, a system 95 for capturing 3D image data and creation of 3D replicas using devices such as smart phones is depicted. 3D image capture 351 by smart phone such as an iPhone (manufactured by Apple Computer, Inc.) consists of capturing a set of images of a static object from minimally sufficient rotationally displaced perspectives around an object. Upon capture the set of images are sent via cloud processing and storage 1000, through a series of processing steps followed by cloud imagining processing through to printing by a networked printer. As those skilled in the art are aware, it should be understood that a smartphone is a mobile phone with an advanced mobile operating system which combines features of a personal computer operating system with other features useful for mobile or handheld use. In another particular embodiment the 3D image capture may be effected by a virtual camera device such as a 3D virtual reality camera (such as a GoPro Omnidirectional manufactured by Orah).

After the image is captured via a device such as a 3D capable iPhone 6 (manufactured by Apple Computer, Inc.) in Step 351, an image processing step 100 consists of determining from zones of overlapping features, the variations in a radial direction about a central reference axis (of the object) of the height of features on the object. Points that are identified from different perspectives are called rectified points and locations in space established because the geometry of the capture devices relative to the object space is known and static. Only points visible in two different views can become rectified, but prior knowledge of the object features will ease the process. To establish this geometry, the physical location of the capture devices relative to the central reference axis can either be measured or fixed, or alternately determined by a calibration process 112 of capturing images from a known object or objects that have overlaid grid patterns for easy rectification of grid points. An image file is created which contains all the appropriate features of the captured 3D image.

After image processing 100, an image file ID 110 comprises a database of image file data comprising identified rectified points from at least two different perspectives and their locations relative to the reference grid images taken during the calibration process 112. The data would preferably be in the form of (r, theta, h) where r is the radius from the reference axis to the rectified point, theta is the rotational position of the rectified point, and h is the height of the rectified point to a base plane perpendicular to the object space reference axis. Referring again to FIG. 1B, the database may include multiple entries for each rectified point as seen from different pairs of perspectives. A subsequent process will statistically determine the best fit values for those points prioritized to generate a suitable replica of the object.

The database created in the image file ID 110 is stored in a storage step 121 which comprises saving the database in a storage unit such as a computer file by any number of ways to correlate the database with object identification so that a replica can eventually be made from the data and can be correctly identified with the original object and circumstances of the image capture, such as illumination, time of exposure, retakes and the like. The storage unit comprises any of various means be they on a hard drive, magnetic tape, recordable compact disc (CDR), or cloud storage. Data stored in storage step 121 may have additional data added to the image file data and this data may be processed further in the Image File ID step 110 as and if additional data is collected or created in the image processing step 100.

After the image file data has been stored, a print job file is created. Cloud or printer network print job file creation 131 consists of the process of setting up the replica making machine with access to the database and recording the object name and other capture variables along with at least one serial number or icon that may be printed directly on the replica for later correlation to the order that promulgated the 3D image capture process 351 to begin with. The printer is given the instructions to print on a networked system and may be present in any of many potential physical locations.

After the 3D replica print job file has been created, a 3D replica or avatar is printed. 3D print operations 141 consists of laying down materials onto a suitable substrate to recreate the (radius, theta, height) variations recorded in the database computer file in a proportional manner on the substrate. The proportional manner refers to the volumetric scale of the replica relative to the original object. The suitable substrate may be a form roughly equivalent to the form of the object, so that amount of materials needed for 3D printing and the time to complete the 3D printing is reduced. It is anticipated that under certain circumstances a complete 360-degree replica is not intended or made, but that a rotational angle of less than 360 degrees is 3D printed even though full 360 degrees data is potentially available in database file. This provides the advantage of allowing the image capture device to be hardwired to the processing unit.

It will be understood by anyone skilled in the art that a multiplicity of materials such as resin, plastic polymers, rubber, and the like may be used for the 3D printing task. In another aspect of the present invention 3D capture of a body part is followed by 3D printing of a replica of said body part with bio-ink or a combination of biocompatible materials leading to a 3D printed prosthesis. In one particular example of 3D prosthesis printing a 3D capture of a nipple is followed by color manipulation and retouching and 3D printing with a bio ink or biocompatible combination of inks and polymers for subsequent placement onto a breast that has undergone mastectomy and where the nipple has been surgically removed.

It will be understood by anyone skilled in the art that the invention is not limited to nipples but to other body parts including but not limited to ears, noses, fingers, toes and such. It will be also understood that certain parts like ears possess mirror image symmetry thereby requiring mirror image treatment of the image data prior to 3D printing in order to duplicate the image pair.

Upon printing the replica, the replica is finalized. Finishing steps 150 consist of polishing the raw printed object prior to printing a final layer on the 3D replica to impart color and density information and a potential protective layer, for example to fix the color, density layer or encapsulate it with waterproofing or ultraviolet protection to prevent the replica from becoming brittle. This may be determined from a fewer number of perspectives than used to determine the rectified points or from different image capture devices. The polishing process may consist of readily known processes such as ablation via compressed fluid be it air, water, sand or any other suitable fluid. In addition the polishing may be done by laser ablation. The laser ablation may be performed on either an avatar to be created or a mold to be used to create the avatar.

After the replica or avatar is finished it gets delivered to the end user. Remote delivery 160 refers to the potential that the image capture device and the 3D printing device may be in entirely separate physical locations. For example, the image capture device may be designed to be portable and taken to a remote location, while the 3D printing device is centrally located serving more than one capture device. Maintaining the centrally located 3D printing devices allows for economies of scale to be used. Remote printing devices may be used to allow for economies of delivery to be realized. So, if a picture is taken in one country but the avatar to be created is to be delivered in a second country then remote printers would be appropriate. Therefore, the delivery of the replica from the 3D printing device may be achieved with services of physical mail or package delivery, while conversely the image capture information from step 351 is digitally transmitted to a central computer database processor by a number of means including telephone, the internet web, or satellite transmission, or combinations thereof, as examples.

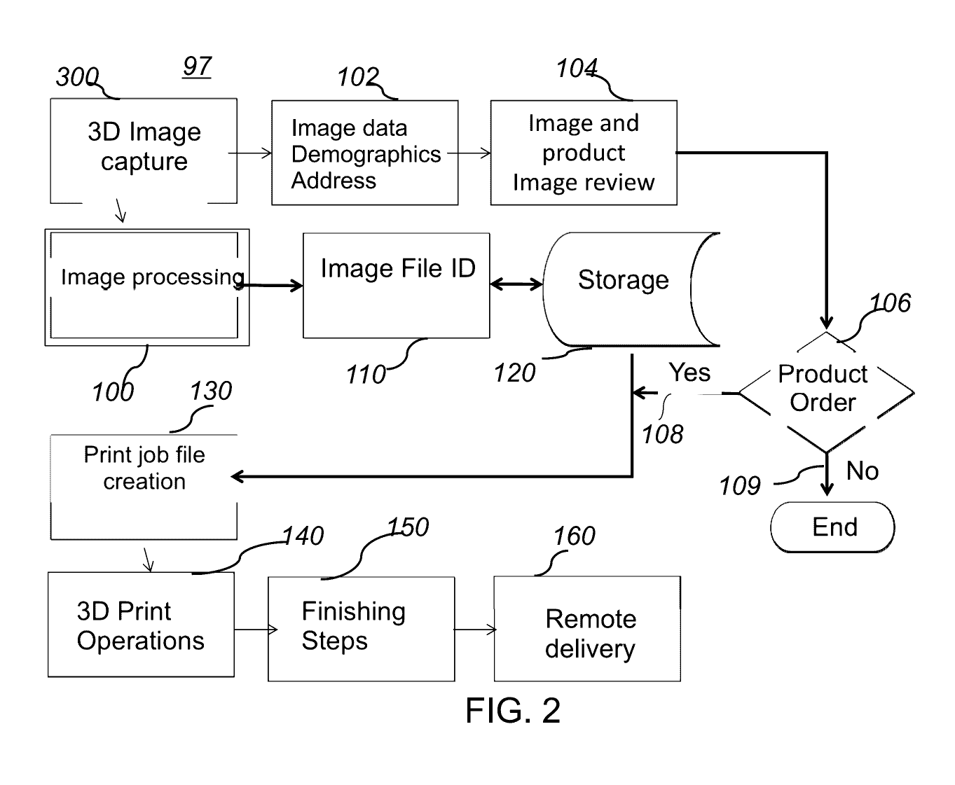

Referring now to FIG. 2 a system 97 of capturing, previewing, processing and printing 3D objects is depicted. The system 97 depicted in FIG. 2 is an elaboration of the system of FIG. 1A with an additional flow path of providing a preview of the image capture results for approval, order generation and offering different output alternatives. In one preferred embodiment the alternatives may be different colors, volumes, proportions and attachments. In another preferred embodiment the image captured may be that of a human subject head whence the resulting solid printed head will be superimposed on a variety of body choices like a uniformed body, a sportsman, a cartoon character, an anime object, or other such mounts. It will be understood by anyone skilled in the art that different types of subjects may give rise to different types of mounts.

Upon capture of a 3D image in step 300 image data demographic address 102 which refers to the correlation data of database identification with the circumstances of the original image capture is added to the data collected in the 3D image capture 300. In a commercial scenario, this consists of a customer's order for the replica with other information pertinent to the initiation of the image capture. This demographic file would eventually be needed to properly deliver the replica made to the person who ordered it. In addition names and addresses may be obtained and linked to the order number.

Upon capturing the customer's demographic data, the customer is provided an opportunity to review the image and product to be created from the image. Image and product image review 104 consists of a proofing method to obtain a customer's approval of the expected replica's appearance before the further processing of data from the image capture is begun. For example, a series of photographic views from various perspectives surrounding the object may be sufficient, or stereographic pairs could be generated and displayed with 3D glasses to impart depth at one or more perspectives. In another setting images may be available on a smart phone display comprising a simple single view or a stereoscopic pair, which may be viewed by appropriate lenses. The purpose of this review is to verify that what was captured is a satisfactory replica suitable for printing.

The replica that is generated in step 104 may be either a two dimensional or a three dimensional representation of the original object. The image may be sent to an appropriate universal resource locator (URL) so that the end user can view the images prior to printing the replica.

Upon reviewing the images and products, the customer is provided an option to order the product. Product order 106 is the decision process to proceed with the replication process. If it is yes 108 as shown then the steps as described above for further image process beginning with print job file creation 130, including database creation, and 3D print operations 140 to begin replica manufacture are enacted leading to finishing steps 150 and ultimately remote delivery 160 of the replica to the customer. Alternatively, if the customer does not wish to place a product order 109, the process may be terminated, or a new image capture scheduled.

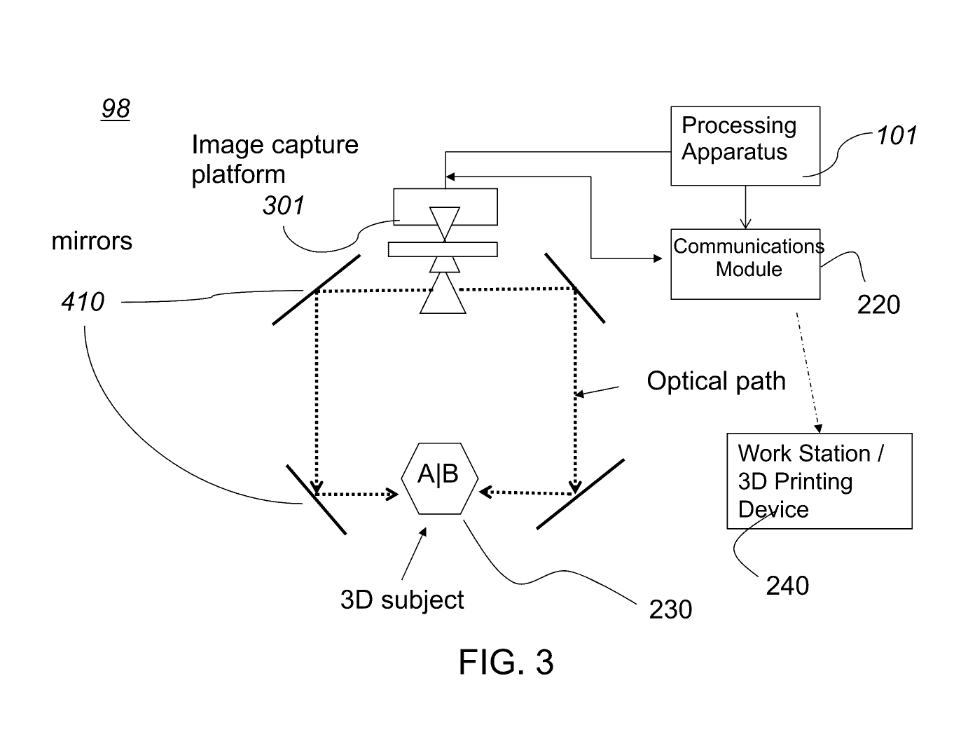

FIG. 3 shows a representative apparatus 98 comprising an image capture platform 301, driven by a processing apparatus 101, wherein the image capture platform 301 is in optical alignment with a set of mirrors 410, and the corresponding 3D subject 230. Image waves from the 3D subject 230 strike the mirrors 410 and are reflected to the image capture device 301. The image capture device 301 may be rotated or individual mirrors 410 may be tilted or a combination of both actions may be performed to allow the image capturing device 301 to capture the image of the 3D subject 230. The image capture device captures a full set of 3D subject features image data and sends the data to a processing apparatus 101 which creates an image data file. The processing apparatus 101 may be connected to the image capturing device 301 via direct wiring or via a communications module 220. The processing apparatus 101 uses algorithms to reduce the size of the image data file while still maintaining enough data to allow the image data to be renderable. The communications module 220 transfers the image data file to work stations 240 located locally or remotely where the 3D image may be rendered as a 3D avatar. The reduced file size allows the communications module 220 to efficiently transfer the image data file. In a preferred embodiment of the present invention, the workstation is a 3D printer and it is used to produce a 3D avatar of the captured image.

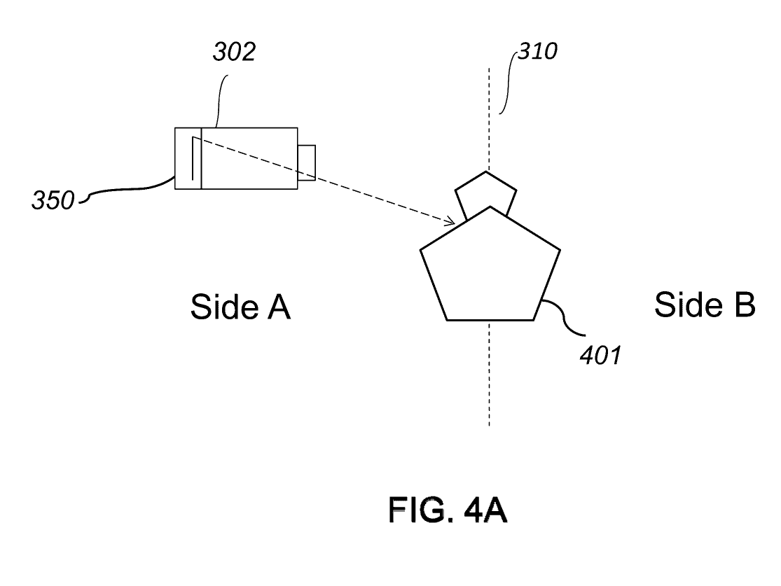

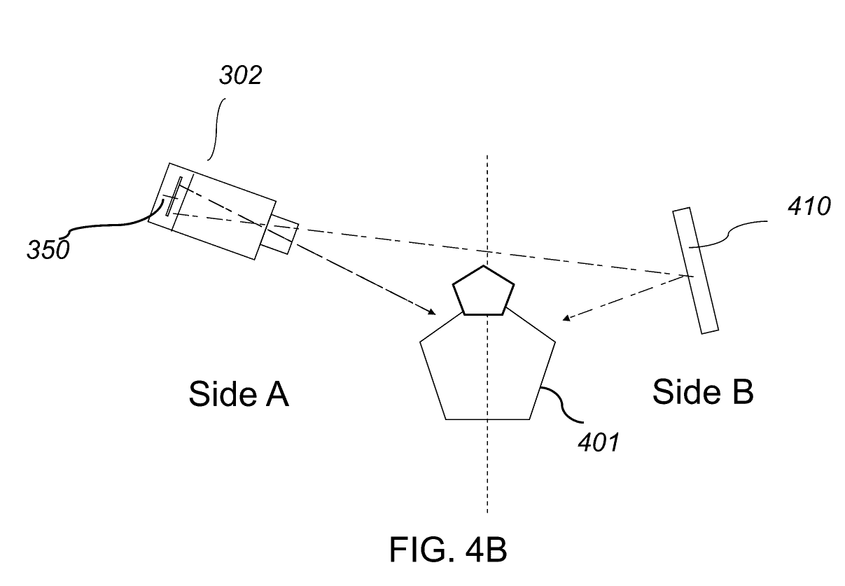

FIG. 4A shows the side view of an area sensor image capture device 302 with split field optics 310 viewing at dual perspectives Side A and Side B of an object 401 simultaneously. The sensor face 350 is split into two fields one of which is recording data from Side A and the other is recording data from Side B. The object may be a human body but is not restricted to that class of objects.

FIG. 4B is a side view of an image capture device 302 with opposite oblique perspectives to capture dual images of the object 401, one directed captured and the second captured via mirror 410. This effectively splits the image sensor 350 into two views shown as Side A and Side B as well known in the trade. Again, the object may be a human body but is not restricted to that class of objects.

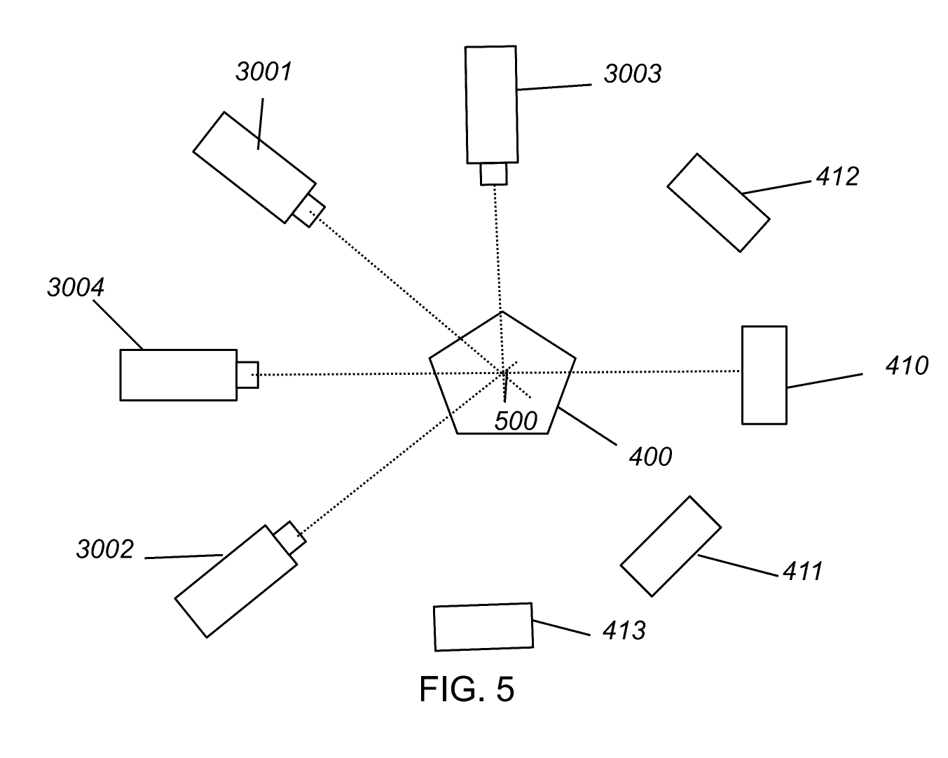

FIG. 5 is a top view of a multiplicity of image capture systems as shown in FIG. 3, though arranged in several circumferential positions. For example, the image capture device 301 and associated reflective mirror 410 can be so oriented to split the sensor field 350 as in FIG. 4A, and different image capture devices (3001, 3002, 3003, and 3004) with associated reflective mirrors (411, 412, and 413) to record data from different positions. Note that the alignment of the components coincide at the center 500 of the object field 400.

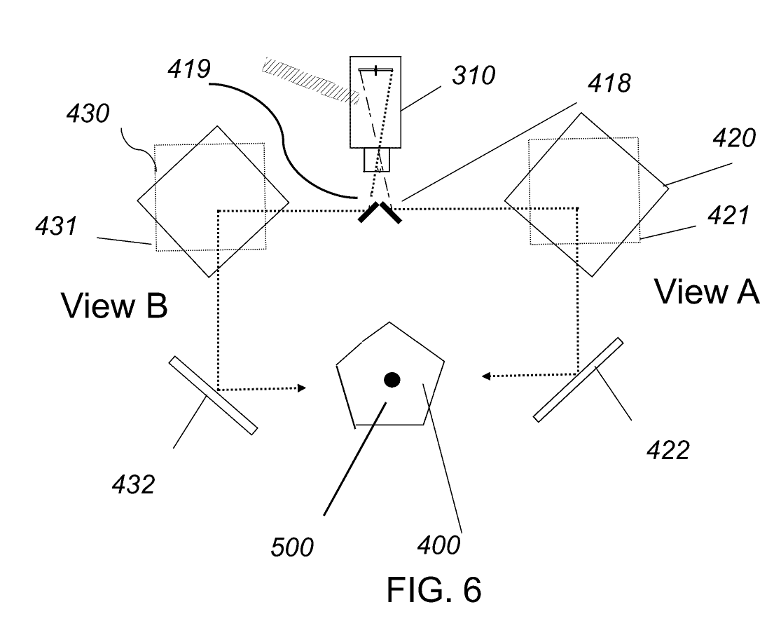

FIG. 6 is the top view of a single area sensor image capture device with split views (A and B) located above the object space aimed outward by mirrors 418 and 419 respectively to 45 degree mirrors 420 and 430, then downward to mirrors 421 and 431 respectively, that are aligned to redirect the optical axes forward to a point midway in the object space to a final set of mirrors 422 and 432 that redirect the optical axes inward toward the center 500 of object space 400. As well known in the trade, this type of reflection combination will cause the split field components to rotate on the face of the sensor 310 the details of which will be described later.

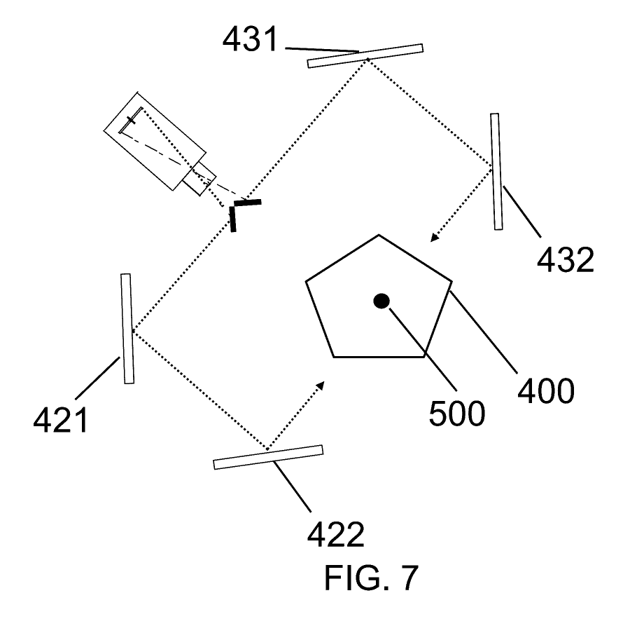

FIG. 7 shows the top view of the same object 400 with the multiplicity of oblique capture devices as depicted in the arrangement of FIG. 6, but rotated to a new perspective angle that could include a relocation of the mirrors typical of 421 plus 422 and 431 plus 432 to a different height location in the object space. The components of FIG. 6 could be repeated a multiplicity of times in the height direction to capture an object that is greater in its height dimension than its cross-sectional dimension. For coordination space orientation, consider the center 500 of the object space 400 from FIG. 6 to be the end view of the Z-axis, such that the View A is directed in the −X direction and the view B is directed in the +X direction. Consequently, components depicted in FIG. 7 are duplicates of the components depicted in FIG. 6, but rotated about the Z-axis. Typically, the various heights of rotated components depicted in FIG. 7 would be made with some image overlap of other rotated components at different heights.

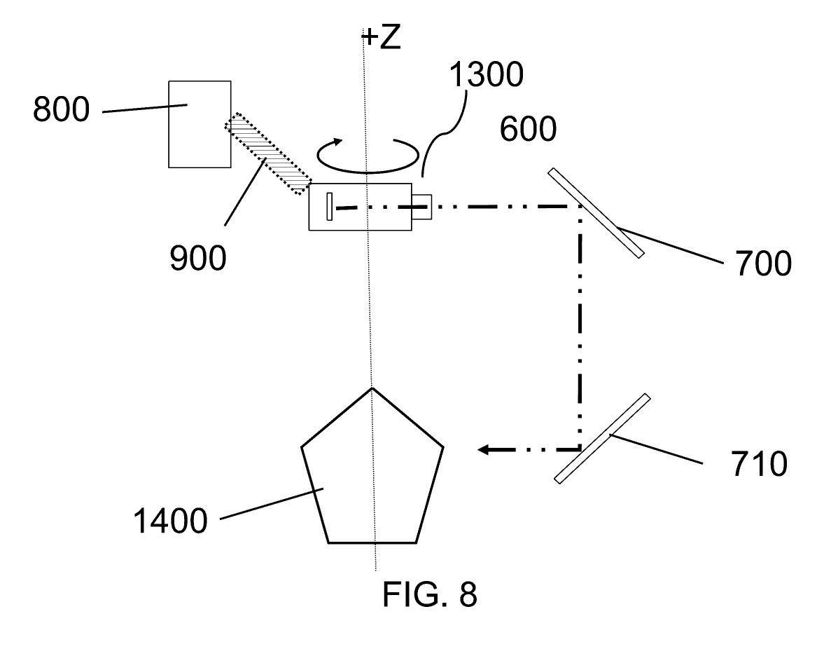

FIG. 8 shows the side view of a different concept utilizing a single image capture device 1300 that is capable of a high frame capture rate and incorporating an area sensor image device similar to the image capture platform 301 (depicted in FIG. 3), which (referring again to FIG. 8) may rotate in one direction about the Z-axis center of the of the object space 1400. The image capture device 1300 is connected to a processing unit 800 via a data bus 900. The perspective axes are directed downward and inward by fixed mirrors 700 and 710. The data bus 900 from the image capture device to the processing unit 800 is preferably a wireless transmission as well known in the trade. The processing unit 800 operates in a manner similar to that used in Step 100 discussed in FIG. 2, Referring again to FIG. 8, the image capture device 1300 power could be an on-board rechargeable battery charged by a deployable physical connection whenever the rotation is stopped.

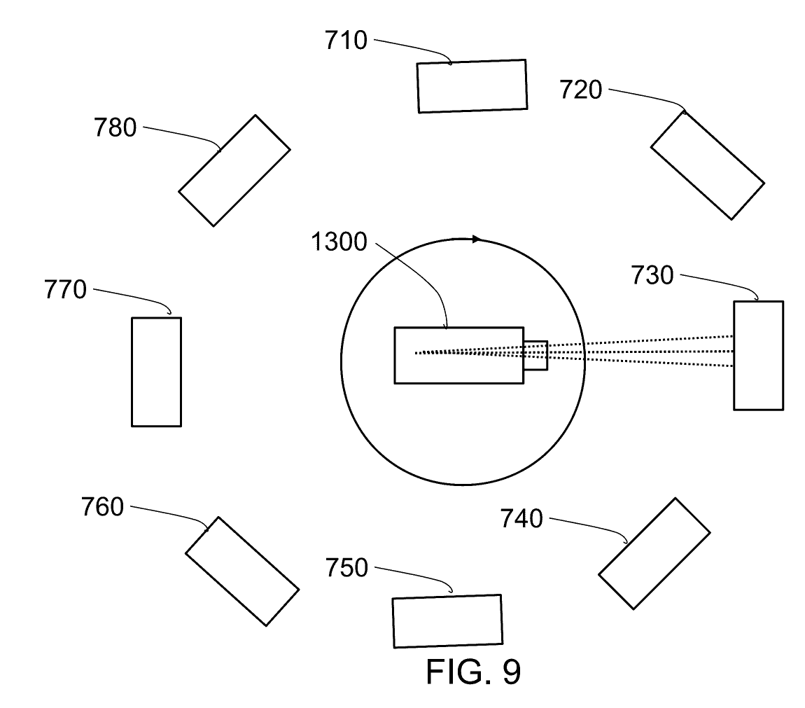

FIG. 9 shows a top view of the system depicted in FIG. 8 indicating the fixed mirrors are replicated at a multiplicity of circumferential locations. The arrangement of the fixed mirrors is similar to that shown in FIG. 4. However, referring again to FIG. 9, this single image capture device 1300 is equipped to record data at a high frame rate relative to the rotational speed to obtain data from many circumferential locations and fixed mirror sets, and perhaps several times as it passes each set of said fixed mirrors shown as lines (710, 720, 730, . . . , 780).

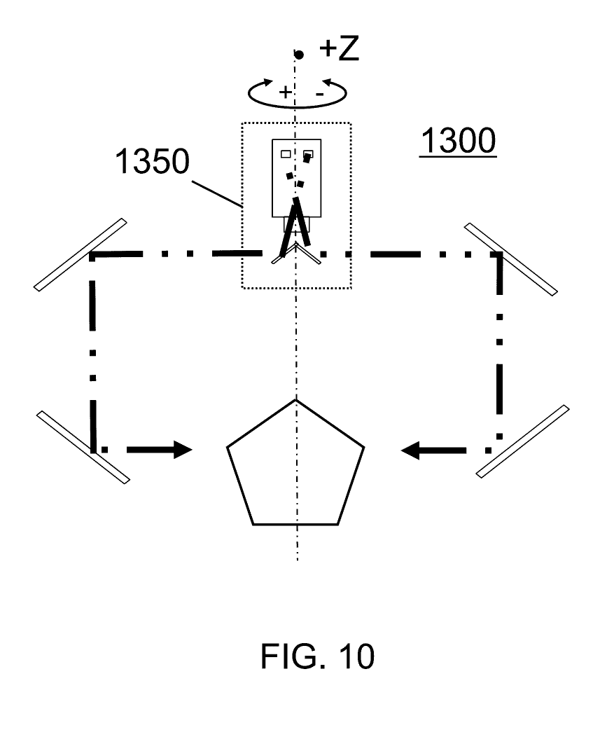

FIG. 10 is a side view of the split field image capture device 1300 coupled with a pair of small 45 degree mirrors, similar to the mirror arrangement as depicted in FIGS. 5 and 9, to rotate as a unit outlined in box 1350 about the Z-axis centered on the object space, and with a high capture frame rate to capture at least one frame from each set of fixed mirrors sets located 180 degrees apart circumferentially, said fixed mirrors repeated a many different perspectives around the object space as discussed with earlier figures. When the split field option is employed, the image capture device need only rotate 180 degrees, thereby allowing for physical connections to the processing unit and camera power source.

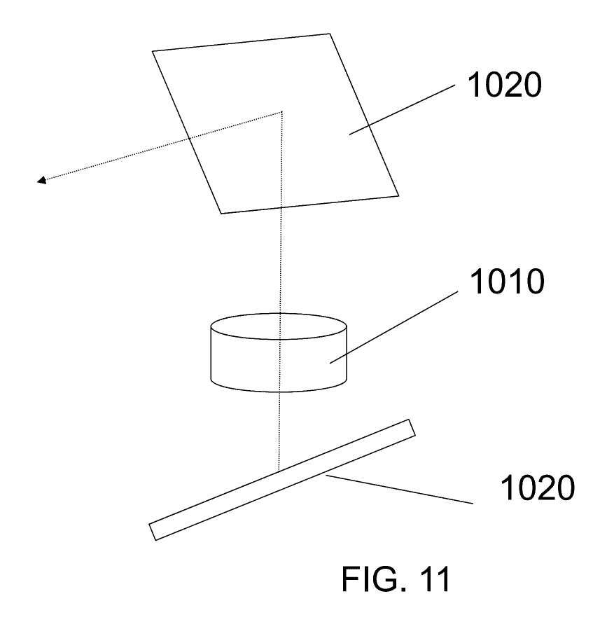

FIG. 11 shows close up detail of a single line sensor image capture device. As shown in the previous figures utilizing full frame area sensors, the first 45-degree mirror 1020 sweeps in any of directions the perspective axis of the camera lens 1010 to one side, however, this is not essential if the camera is oriented to rotate similarly to the camera depicted in FIG. 7. The linear array sensor 1020 has an advantage of a faster capture rate than typical area sensors.

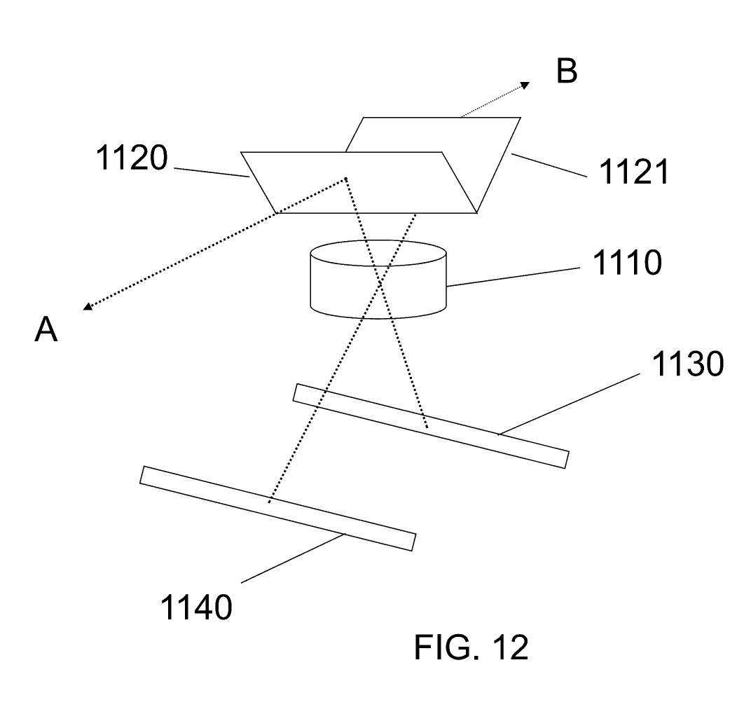

FIG. 12 shows close up detail of a dual single line sensor image capture device. This is similar to the device depicted in FIG. 11 except that 45 degree angle mirrors 1120 and 1121 deliver the images from multiple reflections as shown in earlier optical arrangements, simultaneously. Light from view A is directed to sensor 1130 and light from view B is directed to sensor 1140.

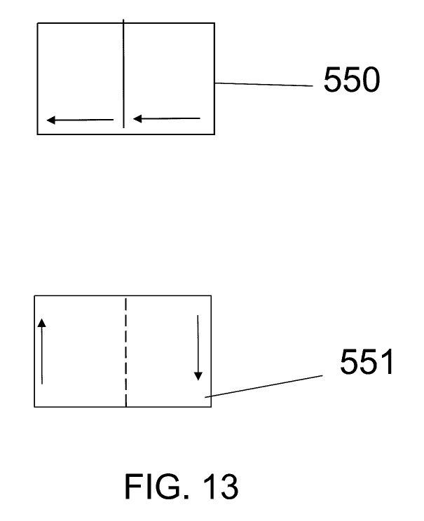

FIG. 13 shows the two options of a split field sensor scenario available by mirror reflections well known to those skilled in the art. Area split 550 is aligned with the long dimension of the sensor so the horizontal references become aligned along the bottom edge and area split 551 is aligned with the long dimension of the sensor so the horizontal references become aligned along the two sides of the sensor and in opposite directions.

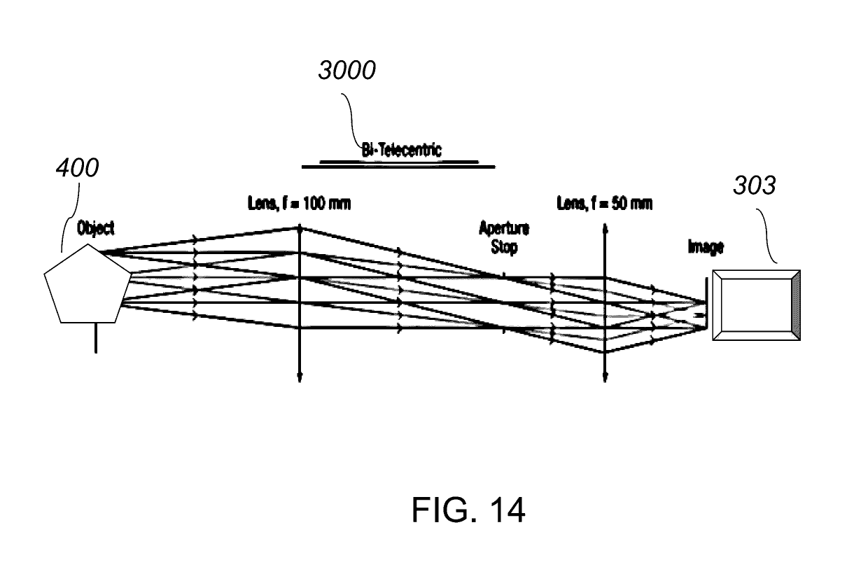

FIG. 14 shows the use of a telecentric lens 3000 image capture device arrangement that could be employed in any of the previous embodiments of the present invention in place of a standard camera lens to capture the image of an object 400. As those skilled in the art are aware, a telecentric lens will transmit an image of the original object 400 that has the same two dimensional sizing as that of the original object 400 itself. As those skilled in the art are aware, the capture device 303 may be any suitable array of photo receptors such as full frame area sensors, a series of linear array sensors, or the like.

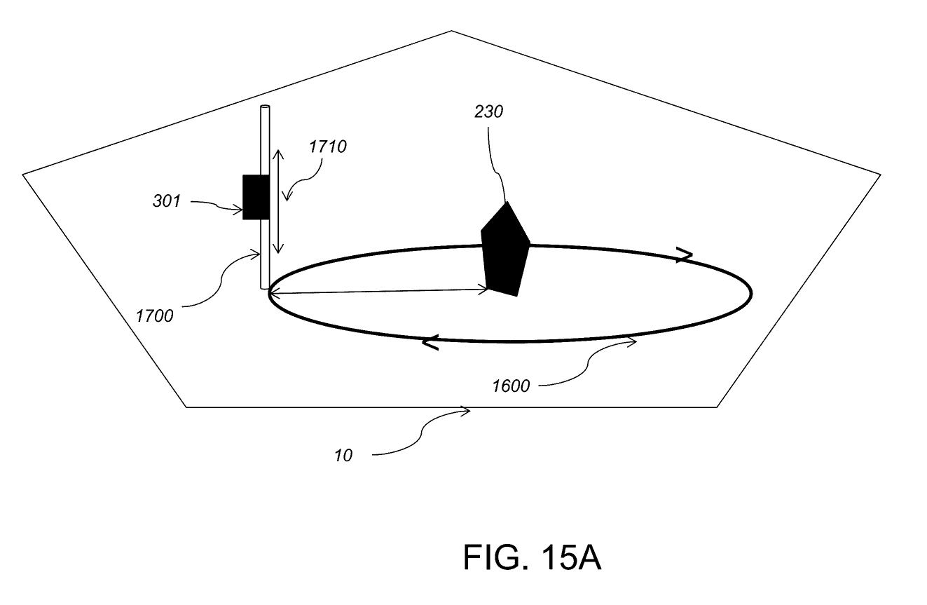

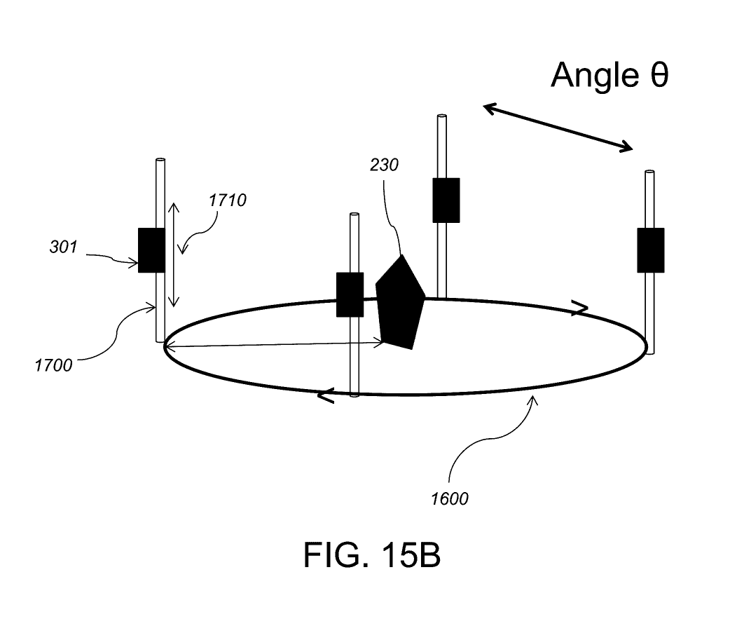

FIG. 15A shows an apparatus for capturing 3D images of a subject 230 wherein at least one image capture device remains stationary on an image capture platform 301 while the subject 230 is located on a rotating platform 1600 in a kiosk 10. The rotating platform 1600 is preferably a turntable such as the HTT-30-PED heavy duty turntable manufactured by A Plus Warehouse of Lynn Mass. The image capture device with adjustable capture device height support 1700 where the image capture device 301 may be adjusted in height and tilt 1710 and rotating subject platform 1600 so that while the image capture platform and all associated wiring connections remain stationary the subject is rotated through a 360 degree arc. The adjustable device support 1700 may be comprised of any suitable support bracket such as the 82-16600 Heavy Duty Camera Mount manufactured by Defender Security of Defender Security of Niagara Falls Ontario Canada mounted upon a support column. Support columns are well known in the art and as such are not further described herein. In another preferred embodiment, additional image capture devices are placed around the rotating subject platform equidistantly apart such that the subject can be rotated through a fraction of a full 360 degree arc. The full amount of rotation necessary being defined by the equation

Θ=360/n (1)
where θ is the angle of rotation (in degrees) and
n is the number of image capture devices.

FIG. 15B shows an image capture platform 301 with four rotating arms 1700. Upon each rotating arm at least one image capture device is mounted. In the preferred embodiment, each image capture device is a smart phone equipped with a 3D capture app. In one preferred embodiment two smart phones are each mounted upon a rotating arm. The rotating arm may be comprised of any structural support column well known in the art and may be mounted by any readily available means to allow for rotation such as mounting in a track or to an arm connected to a rotating hub or the like. The rotating arm may be propelled mechanically or manually. As the rotating arms are rotated through 90 degrees, each smart phone is recording the image and an entire set of images of the object is obtained. This has the benefit of reducing the amount of time that the subject or subjects need to remain stationary to record a complete set of images. As will be readily apparent, if four cameras are mounted upon four rotating arms, the complete image of the subject can be obtained in ¼ the time for a single smart phone to capture all the images. Likewise three smart phones on three rotating arms can obtain a complete image of the subject in ⅓ the time for a single smart phone to capture all the images and eight smart phones on eight rotating arms can obtain a complete image of the subject in ⅛th the time it would take for a single smart phone to capture all the images. By mounting additional smart phones on each rotating arm, a higher image resolution may be obtained than by simply using one smart phone per rotating arm. Additionally as with the image capture platform 301 adjustable capture device support arm 1700 depicted in FIG. 15A, the adjustable capture device support arm 1700 depicted in FIG. 15B may also have the height and tilt adjusted 1710.

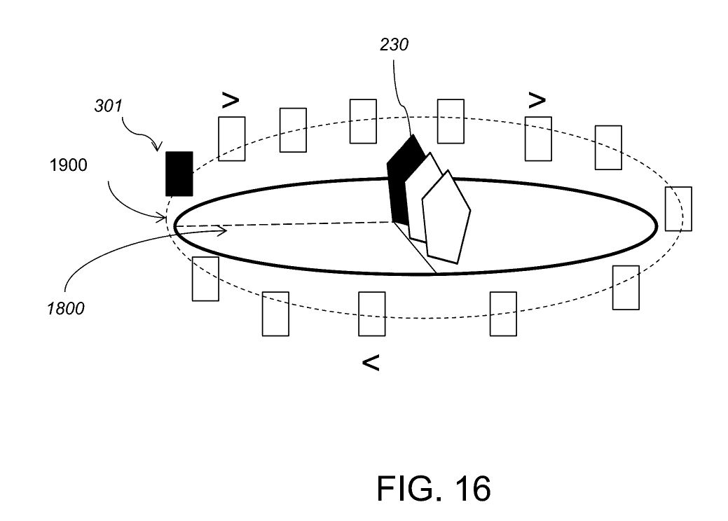

FIG. 16. shows an image capture device 301 orbiting an image capture platform 1900 about an stationary subject 230 positioned along a radially graded axis 1800. The path the image capture platform follows may be circular, hyperbolic, or elliptical as is necessary to maintain the optimal focal length between the image capture device and the subject or subjects being imaged. The appropriate path for the image platform to travel will be easily determined by those skilled in the art based upon the dimensions of the subjects.

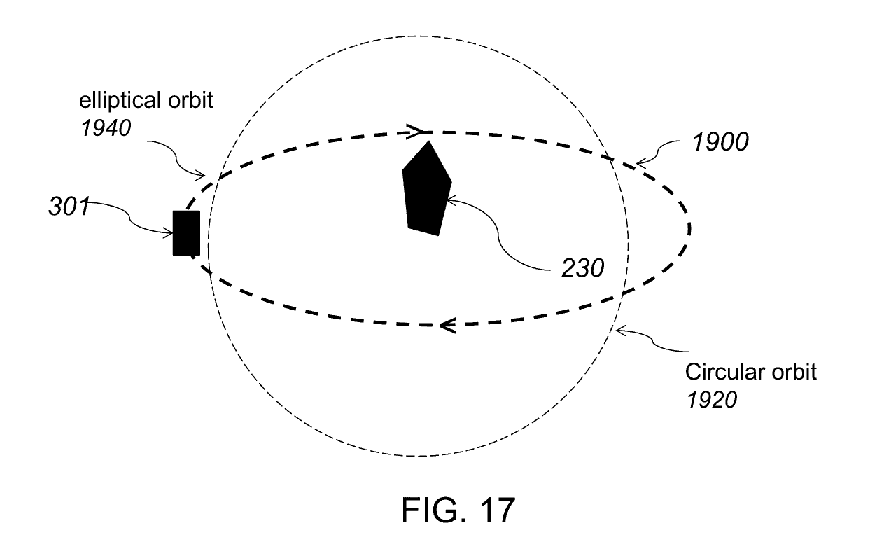

FIG. 17 shows the image capture device 301 from FIG. 16 in a platform rotating in a track 1900 about a stationary Subject 230 positioned along a radially graded axis where the rotation about the subject 230 may be a circular 1920, hyperbolic, or an elliptical orbit 1940. The circular and elliptical paths are depicted in the FIG. 17.

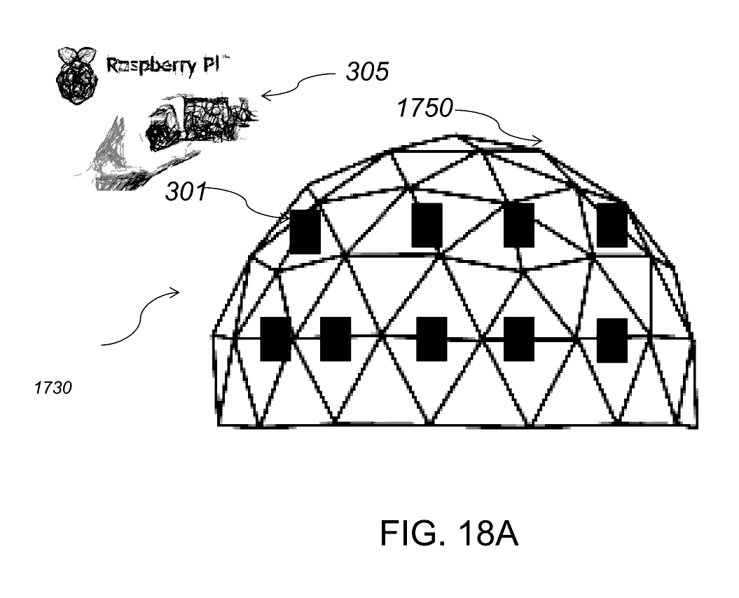

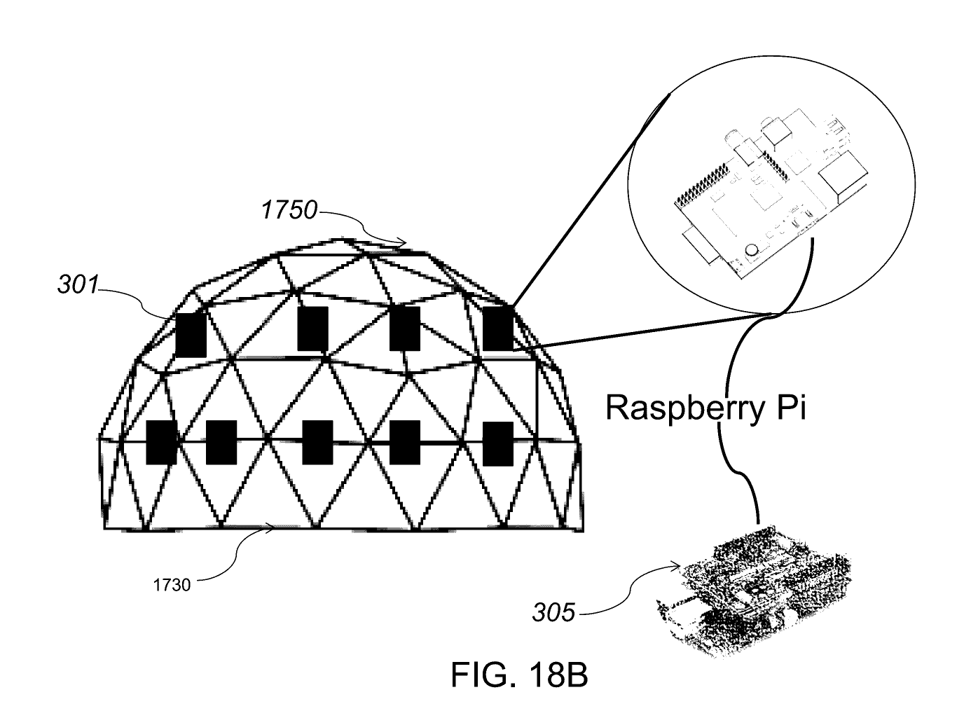

FIGS. 18A and 18B show a series of image capture devices 301 mounted in a portable kiosk. The portable kiosk comprises a shell comprised of any lightweight construction support material such as structural aluminum, wood, composite tubing, and the like; such materials are well known in the art. In one preferred embodiment, the kiosk shell is arranged in a geodesic lattice which allows for additional strength and rigidity of the structure and also allows for adjustability of the image capture device support 1730. The image capture device support 1730 is adjustable to allow for optimal placement of the cameras in the portable kiosk 1750. The image capture device support 1730 is preferably an adjustable bracket such as the 82-16600 Heavy Duty Camera Mount. The image capture device may be controlled via demountable Raspberry Pi™ controllers 305.

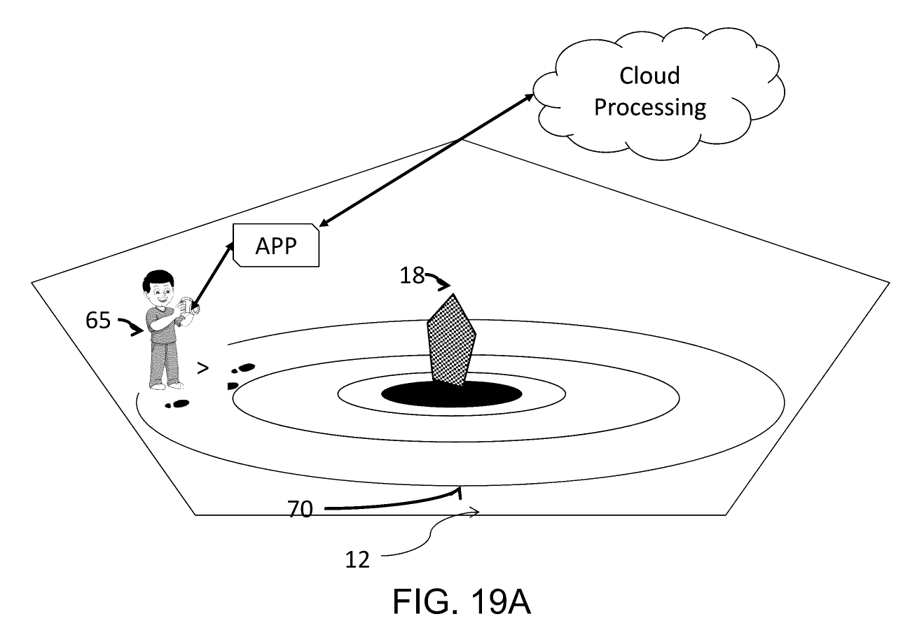

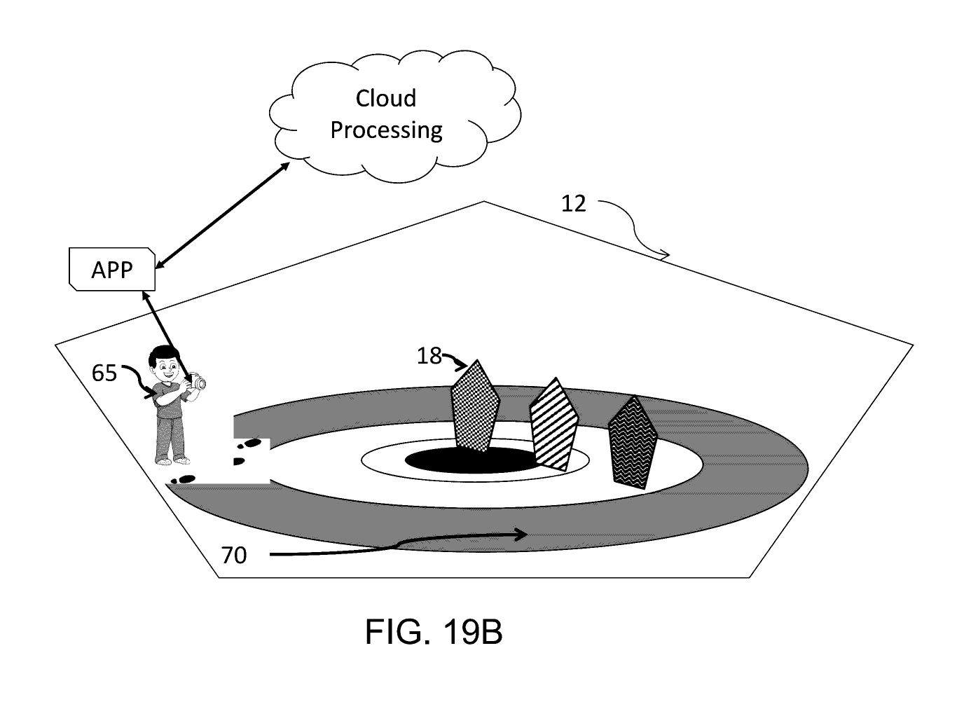

FIGS. 19A and 19B show another embodiment of the present invention. A kiosk 12 for taking 3D pictures is depicted. The kiosk 12 is equipped with a canopy with a cover comprising a suitable material selected to diffuse light which allows for diffused light to provide the lighting for a subject. As those skilled in the art are aware, suitable materials to diffuse light include artificial silk, poly silk, chiffon, Mylar™, sailcloth, styrene, acrylic, tight weave polyesther, nylon, lightly woven cotton, and the like. A non-exhaustive sampling of representative light diffusers which may be used with the present invention include the opal styrene light diffuser made by Ridout Plastics of San Diego, Calif., the 5 in 1 Portable 24×36″/60×90 cm Round Collapsible Multi Disc Photography Studio Photo Camera Lighting Reflector/Diffuser Kit manufactured by Neewer of Guangdong, China, and the 452 sixteenth white diffusion manufactured by Lee Filters of Andover, Hampshire, United Kingdom, and the Tough White Diffusion #3026 manufactured by Roscoe of Stamford Conn. In a preferred embodimenet, the light diffuser is white. The kiosk canopy is preferably compact and lightweight and collapsible to allow for easy transport. The kiosk will be large enough to accommodate at least one subject and at least one kiosk operator. Although the subject may be human, it will be obvious to those skilled in the art that the subject may be an inanimate object such as a car, an article of clothing, a small structure, and the like or the subject may be an animate object such as a person, a pet animal, or the like. For capturing images of a single subject, in one preferred embodiment the kiosk dimensions may be about 9 feet wide by about 7 feet long by about 59 inches tall. In another preferred embodiment the kiosk dimensions may be about 11 feet wide by about 9 feet long by about 72 inches tall. In yet another preferred embodiment the kiosk dimensions may be about 14 foot wide by about 8 foot long by about 74 inches tall. Preferred materials of construction of the kiosk shell include a fabric comprising canvas, a weaved nylon, a polypropylene mesh, and the like. The kiosk shell may be supported by any light weight easily transportable framework such as collapsible tent poles such as those found on the Bass Pro Shops Eclipse 8 person dome tent. The kiosk 12 also is equipped with an image capture template mat 70 (mat) for the subject 18 to remain on while 3D images are captured. The mat may preferably be constructed of lightweight puncture resistant and tear resistant materials such as outdoor carpeting, felt, artificial turf, playground flooring (poured rubber, preformed connectable rubber tiles), plywood, vinyl, rubber, ethylene vinyl acetate foam, and the like. In a preferred embodiment, the mat is flexible. The mat 70 is equipped with markings for a single subject or multiple subjects to remain at while the images are captured. The mat 70 is also equipped with markings to allow a person taking the subject's photos, hereafter referred to as the kiosk operator 65, to know the optimal distance to stay from the subject 18 or subjects while the images are being collected. The markings for collecting images of a single subject are circular and indicating the ideal focal length for the image capture device. The markings for collecting images of multiple subjects are elliptical and indicating the ideal focal length for the image capture device. The preferred image capture device is a smartphone such as an I-Phone™ equipped and enabled with 3D image capturing. The smartphone is equipped with an computing application (app) which sets the smartphone camera settings to a fixed focal length and a fixed aperture which allows for both consistent dimensioning and consistent lighting. The app further sets the number of frames to be collected. The kiosk operator 65 follows the markings on the mat and traverses around the subject 18 collecting the subject's images. The app transfers the camera's images automatically to a datastore located on the cloud. The app uses algorithms based upon the lighting conditions of the kiosk 12 to determine the optimal aperture settings. From the cloud, the captured images may be used to create a print file and the print file may be transferred to a 3D printer for final avatar creation. The app also uses algorithms to allow the subject to purchase the 3D printed avatar.

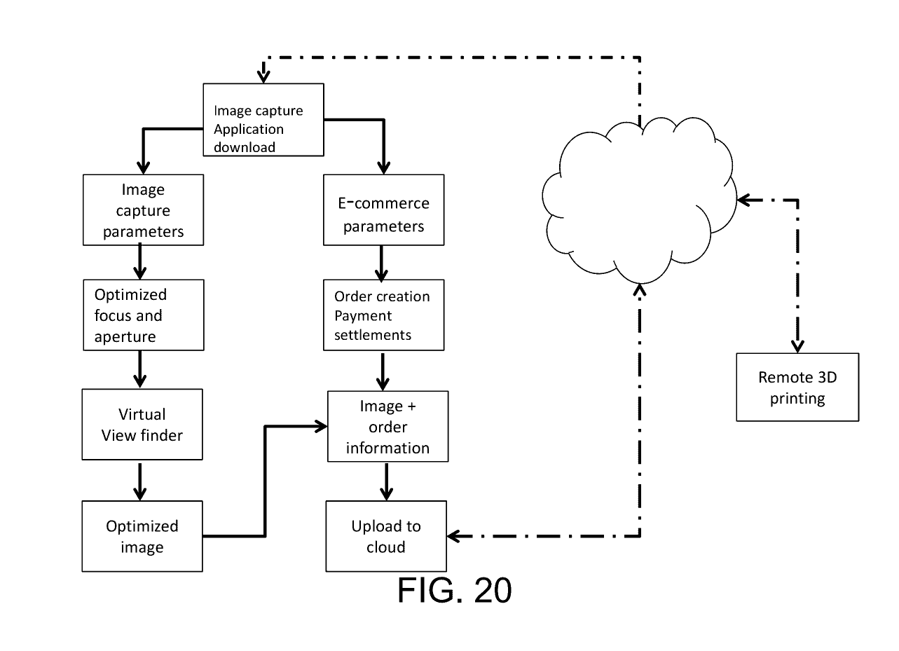

FIG. 20 depicts a method for using the system of FIGS. 19A and 19B. In the initial step, the kiosk user downloads an Image Capture Application (app) from the cloud to their smartphone. The app sets the image capture parameters for the phone based upon the lighting conditions in the kiosk. The app optimizes the focal length and aperture of the camera. The kiosk operator 65 has the at least one subject take a place at the center of the mat. The kiosk operator 65 sets himself up along the marked path on the mat. The kiosk operator 65 uses a virtual viewfinder set up on the smartphone by the app and walks around the subject while taking pictures of the subject. The app optimizes the images for 3D printing.

The app also determines e-commerce parameters to allow the subject or a representative of the subject to select and order an avatar of their choosing. After subject or his representative chooses to place an order, the app creates the order and arranges for payment and settlement of payment. The app may make use of existing e-commerce platforms such as PayPal to complete the transaction. The optimized image and order information are combined into a data file and the data file is uploaded to the cloud. From the cloud, a remote 3D printing station is accessed and the order may be printed and the 3D avatar delivered to the subject's preferred destination.

Although several embodiments of the present invention, methods to use said, and its advantages have been described in detail, it should be understood that various changes, substitutions, and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged device.

We claim:

1. A method of remotely capturing 3 dimensional information optimized for 3 dimensional printing comprising an optical system aligned to capture at least one image perspective suitable to serve as input to a 3D printing device, wherein the optical system comprises an 3D image capture device, the method comprising the steps of;
a) capturing at least two perspectives of an object;
b) creating an image file of the object;
c) identifying rectified points through image data manipulation algorithms;
d) generating a 3 dimensional printing model using depth information obtained from the rectified points;
e) transmitting the depth data via a communications module to a 3D printing device;
f) using the 3D printing device to reproduce a negative or positive replica of the rectified points.

2. The method of claim 1 where the 3D image capture device is a 3D-capture-enabled smartphone.

3. The method of claim 1 wherein the 3D image capture device is a smart phone, an area sensor camera with split field optics; one single area sensor camera with a high frame rate; a single line sensor camera with high frame rate; or a dual single line sensor camera with high frame rate and with split field optics.

4. The method of claim 1 where the 3D image capture device comprises a telecentric lens wherein both lenses of the telecentric lens are in optical alignment selected to capture 3-dimensional perspectives of the object's image.

5. The method of claim 1 further comprising the step of laser finishing.

6. A portable and mobile apparatus for capturing 3 dimensional information optimized for 3 dimensional printing comprising an optical system aligned to capture at least two image perspectives suitable to serve as input to a 3D printing device comprising;
a) an electronic image capture device;
b) at least two mirrors;
c) said electronic image capture device optically aligned with said mirrors to capture an image of at least one perspective of an object;
d) a processing device;
e) said processing device comprising a first set of built in algorithms and a second set of built in algorithms;
f) said first set of built in algorithms identifying rectification points of said image;
g) said second set of built in algorithms developing a model;
h) a data storage ability;
i) an electronic business engine to create an order;
j) a communication module; and
k) transmission of order information via a communications channel;
l) and a 3 dimensional printer wherein
m) said communication module transmits order information over said communications channel to said 3D printer; and
n) said 3D printer reproduces a negative or positive of the rectified points.

7. The apparatus of claim 6 where the 3-dimensional printer is a cylindrical coordinate 3-dimensional printer.

8. The apparatus of claim 6 where the image capture device is a 3D-capture-enabled smartphone.

9. The apparatus of claim 6 where the image capture device comprises a telecentric lens wherein both lenses of the telecentric lens are in optical alignment selected to capture 3-dimensional perspectives of the object's image.

10. The apparatus of claim 6 further comprising a geodesic lattice wherein the geodesic lattice comprises reference points wherein the image capture devices are mounted upon said reference points on the geodesic lattice and the mounts are mounted such that the image capture devices can be arranged into a preferential arrangement optimized to the specific parameters of the object allowing for ideal capture of the object image.

11. The apparatus of claim 10 wherein the geodesic lattice allows for easy entrance of the object into the portable and mobile apparatus.

12. The apparatus of claim 10 wherein the electronic image capture device is a multiplicity of Raspberry Pi™ devices.

13. The apparatus of claim 6 wherein said electronic image capture device is a smart phone, an area sensor camera with split field optics; one single area sensor camera with a high frame rate; a single line sensor camera with high frame rate; or a dual single line sensor camera with high frame rate and with split field optics.

14. The apparatus of claim 6 wherein the communications module utilizes the cloud for data transmission, processing, manipulation, and storage.

15. The apparatus of claim 6 wherein the object is alive and sentient.

16. The apparatus of claim 15 further comprising a live monitor wherein said monitor depicts attention drawing artifacts which keep the object's attention focused and allows for the object to remain stationary while the image is captured.

17. The apparatus of claim 6 wherein the image capture device comprises a telecentric lens wherein both lenses of the telecentric lens are in optical alignment selected to capture 3-dimensional perspectives of the object's image.

18. A portable and mobile apparatus for capturing 3 dimensional information optimized for 3 dimensional printing comprising an optical system aligned to capture at least two image perspectives of at least one subject, wherein the at least two image perspectives are suitable to serve as input to a 3D printing device comprising;
a) an electronic image capture device;
e) a processing device;
f) said processing device comprising a first set of built in algorithms and a second set of built in algorithms;
g) said first set of built in algorithms identifying rectification points of said image;
h) said second set of built in algorithms developing a model;
i) a data storage ability;
j) an electronic business engine to create an order;
k) a communication module; and
l) transmission of order information via a communications channel;
m) and a 3 dimensional printer wherein
n) said communication module transmits order information over said communications channel to said 3D printer; and
o) said 3D printer reproduces a negative or positive of the rectified points, wherein said electronic image capture device is a smart phone and said smart phone is rotated about the subject.

19. The apparatus of claim 18 further comprising a multiplicity of rotating arms and a multiplicity of smart phones, wherein at least one smart phone is mounted upon each rotating arm.

20. The apparatus of claim 19 wherein there are four rotating arms and four or eight smart phones.

21. A portable and mobile apparatus for capturing 3 dimensional information optimized for 3 dimensional printing comprising an optical system aligned to capture at least two image perspectives of at least one subject, wherein the at least two image perspectives are suitable to serve as input to a 3D printing device comprising; a kiosk, a smart phone, and an image capture template mat; said kiosk being readily deployable and further comprising a shell, said shell comprising a canopy wherein said canopy has a cover comprising a suitable material selected to diffuse light; said smart phone is equipped with a computer application wherein said computer application determines image capture parameters based upon ambient lighting conditions; and said image capture template mat comprises at least two sets of markings, wherein said first set of markings indicates wherein the subject shall be located during the image capture and wherein said second set of markings indicates where a kiosk operator will traverse around the subject capturing a multiplicity of images; wherein said computer application sends the captured images to the cloud for image processing and to create a print file; and the print file is transferred from the cloud to a three dimensional printer, said three dimensional printer printing an avatar of the image.

22. The portable and mobile apparatus of claim 21 wherein said computer application further comprises a view finder.
